(19) United States
(12) Patent Application Publication
(10) Pub. No.: US 2008/0155016 A1
(43) Pub. Date: Jun. 26, 2008

(54) CONTENT PROCUREMENT ARCHITECTURE

(76) Inventor: WEI K. TSAI, Irvine, CA (US)

Correspondence Address: FRANK F. TIAN, 331-4A THIRD AVENUE, LONG BEACH, NJ, 07740, US

(21) Appl. No.: 11/962,006

(22) Filed: Dec. 20, 2007

Related U.S. Application Data
(60) Provisional application No. 60/871,556, filed on Dec. 22, 2006.

(51) Int. Cl. G06F 15/16

(52) U.S. Cl. 709/203

(57) ABSTRACT

There is provided an architecture (system and method) to accelerate web response time and to provide a level platform to meet the interests from both providers and users of content. The concept of user object is introduced to present user interests or disinterests. If a user's browser has already cached a particular provider object, then a corresponding user object indicates that the user is not interested in that object. Otherwise, a user can indicate his/her interests in objects specified either by a set of criteria or explicit description of objects. The web response is accelerated by generalization of the split-proxy architecture of content networking. The user is represented by the user proxy and browser proxy 34. Unlike the traditional content delivery architecture, the content procurement architecture pushes user interests close to the provider sites and minimizes the request-response time between the user proxy and the provider proxy. The request-response sequence is accelerated by pipelining and minimizing all unnecessary stop-and-wait actions.

### REFERENCE TO RELATED APPLICATIONS

This application claims an invention which was disclosed in Provisional Application No. 60/871,556, filed Dec. 22, 2006 entitled “CONTENT PROCUREMENT ARCHITECTURE”. The benefit under 35 USC §119(e) of the U.S. provisional application is hereby claimed, and the aforementioned application is hereby incorporated herein by reference.

### FIELD OF THE INVENTION

The present invention generally relates to a system and method of content procurement from individual clients in an IP network, and more particularly, to a system and method to reduce response time in acquiring content from content providers to individual clients by caching and pipelining web requests and responses.

### BACKGROUND OF THE INVENTION

The background of the present invention relates to that generally is known as content networking over the Internet, and more generally, over any IP network.

Traditionally, content networking is described frequently as content delivery or content distribution for the reason that a key idea is to move content closer to the users (or clients) to minimize latency and maximize throughput. It is a well-known fact that the average TCP throughput is inversely proportional to the RTT (round trip time) between the sender and the receiver.

The emphasis is therefore on distributing content closer to the clients. This form of distribution is often known as web caching, and is generally accomplished through layers of proxy servers distributed mostly near the edge of the core network.

Content networking has multiple objectives, and the two most common among them are: minimizing web access latency and maximizing throughput. The present invention focuses on minimizing web response time.

Two techniques are commonly employed: pre-fetching and pipelining. Pre-fetching is the technique that a proxy of a client pre-parses an HTML file downloaded from a web site and requests in advance (without explicit participation from the client browser) all the embedded objects in the HTML file. The problem or disadvantage of pre-fetching is that the browser might have already cached some of the embedded objects, and many of the objects fetched might not be needed at the browser, thus wasting both time and bandwidth resources at the client side.

Pipelining is the other major technique for web acceleration technique. While pre-fetching is optimization in the content domain, pipelining is optimization in the time domain. The key to pipelining is that any stop-and-wait actions must be minimized or eliminated.

In today's network, all technologies improve as timeprogresses. However, as the speed of light remains the same, propagation delay between two physical locations will remain the same, no matter how much technologies have improved. Therefore, as technologies improve over time, the bottleneck will increasingly be the response time of protocols for web content. The present invention is designed to concentrate on this particular fact.

In today's content delivery framework, proxies are extensively used for caching web content at locations near the end users. This model reflects a complete bias against the end users. Content procurement from the Internet can be likened to a real-estate transaction: content providers are likened to sellers, end users are likened to buyers, and proxy servers are likened to be agents. Under this analogy, the current framework has no or little provision for buyer agents. The proxies are basically seller agents that push content to buyers; while the buyers have no agents to represent them in the network.

The closest proxy architecture that gives clients a representation is that of split-proxy. In split-proxy architecture, clients are represented by cproxy 12 (client proxy) servers and providers are represented by sproxy 14 (server proxy) servers.

The present invention is a generalization of the split-proxy architecture and represents a major step forward in provisioning agents for users closer to the content providers. In the current split-proxy architecture, the cproxy 12 usually resides inside the user terminal, for example, a cell phone or a laptop computer.

Currently, the trend in content networking is that all commercial web sites are moving toward personalized rendering of content. Such personalization leads to increasingly larger amount of dynamic content. Truly dynamic content cannot be shared among different users; thus making caching less and less effective. As of this writing, the percentage of dynamic content has caused the hit rates at web caching proxies to drop to 40-50%. As time moves on, more dynamic content will mean that a different strategy is needed.

The current setup of web proxy is to leverage on shared content between different users. However, as dynamic content becomes dominant, the chance of sharing content between users becomes increasingly smaller. In the extreme case, when no sharing is possible among users, the best place for caching content is actually the user's own browser cache; the chance of repeated requests for the same content is much higher for a single user than for two different users. It is in this sense or scenario that a new client driven architecture is needed for web acceleration. The present invention provides such an architecture.

### SUMMARY OF THE INVENTION

It is therefore, an object of the present invention is to provide a system and method (architecture) to minimize response time in content delivery over the Internet.

It is yet another object of the present invention to enhance the client interests in the content networking infrastructure.

It is yet another object of the present invention to cache clients' interests in the form of lists of embedded objects on the proxies to increase the efficiency of pre-fetching.

It is yet another object of the present invention to provide an architecture that allows pushing client proxies closer to the content provider sites to minimize the RTT between client proxies and the content sites; thus shortening the response time for dynamic content delivery.

It is yet another object of the present invention to provide an architecture that maximizes caching efficiency by sharing content among users of the same type.

It is yet another object of the present invention to provide a client-driven architecture for content networking. Such architecture enables end-user services that tailor to end customer need for fast web content download.

It is yet another object of the present invention to provide a client-driven architecture that will collaborate with the current provider-driver architecture.

There is provided an architecture (system and method) to accelerate web response time and to provide a level platform to meet the interests from both providers and users of content. The concept of user object is introduced to present user interests or disinterests. If a user's browser has already cached a particular provider object, then a corresponding user object indicates that the user is not interested in that object. Otherwise, a user can indicate his/her interests in objects specified either by a set of criteria or explicit description of objects. The web response is accelerated by generalization of the split-proxy architecture of content networking. The user is represented by the user proxy and browser proxy 34. Unlike the traditional content delivery architecture, the content procurement architecture pushes user interests close to the provider sites and minimizes the request-response time between the user proxy and the provider proxy. The request-response sequence is accelerated by pipelining and minimizing all unnecessary stop-and-wait actions.

### BRIEF DESCRIPTION OF THE DRAWINGS

The above and other objects and features in accordance with the present invention will become apparent from the following descriptions of preferred embodiments in conjunction with the accompanying drawings, and in which:

FIG. 1 shows the two rounds of HTTP messages.

FIG. 2 shows the basic structure of pipelining of HTTP response.

FIG. 3 shows the basic structure of split-proxy embodiment of CPA

FIG. 4 shows a hash of related objects

FIG. 5 shows a table of embedded object list

FIG. 6 shows 1st-round request handling

FIG. 7 shows a UML action diagram of the Browser Proxy's control flow

FIG. 8 shows a table of three classes of handling embedded objects

FIG. 9 shows an example of embedded third-party URL

FIG. 10 shows request handling Interaction Diagram

### DETAILED DESCRIPTION OF THE PRESENT INVENTION

Certain embodiments as disclosed herein provide for a MAC module that is configured to be deployed in a wireless communication device to facilitate multi-hop wireless network communications over high bandwidth wireless communication channels based on UWB, OFDM, 802.11/a/b/g, among others. In one embodiment, the nodes involved in the multi-hop wireless communications are arranged in a mesh network topology. For example, one method as disclosed herein allows for the MAC module to determine the network topology by parsing beacon signals received from neighbor nodes within communication range and establish high bandwidth communication links with those nodes that are within range to provide a signal quality that supports high bandwidth communication. For applications that require a certain level of quality of service, the methods herein provide for establishing a multi-hop end-to-end route over the mesh network where each link in the route provides the necessary level of signal quality.

After reading this description it will become apparent to one skilled in the art how to implement the invention in various alternative embodiments and alternative applications. To facilitate a direct explanation of the invention, the present description will focus on an embodiment where communication is carried out over a UWB network, although the invention may be applied in alternative networks including 802.11, 802.15, 802.16, worldwide interoperability for microwave access (“WiMAX”) network, wireless fidelity (“WiFi”) network, wireless cellular network (e.g., wireless wide area network (“WAN”), Piconet, ZigBee, IUP multimedia subsystem (“IMS”), unlicensed module access (“UMA”), generic access network (“GAN”), and/or any other wireless communication network topology or protocol. Additionally, the described embodiment will also focus on a single radio embodiment although multi-radio embodiments and other multiple input multiple output (“MIMO”) embodiments are certainly contemplated by the broad scope of the present invention. Therefore, it should be understood that the embodiment described herein is presented by way of example only, and not limitation. As such, this detailed description should not be construed to limit the scope or breadth of the present invention as set forth in the appended claims.

Before addressing details of embodiments described below, some terms are defined or clarified. As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, use of the “a” or “an” are employed to describe elements and components of the invention. This is done merely for convenience and to give a general sense of the invention. This description should be read to include one or at least one and the singular also includes the plural unless it is obvious that it is meant otherwise.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

In the following description of the invention, single-medium multiple-access communication systems are assumed to be the intended applicable systems. This assumption is in no way a restriction of the general applicability of the present invention.

An analysis of the request-response style of the HTTP protocol provides the clue to latency minimization.

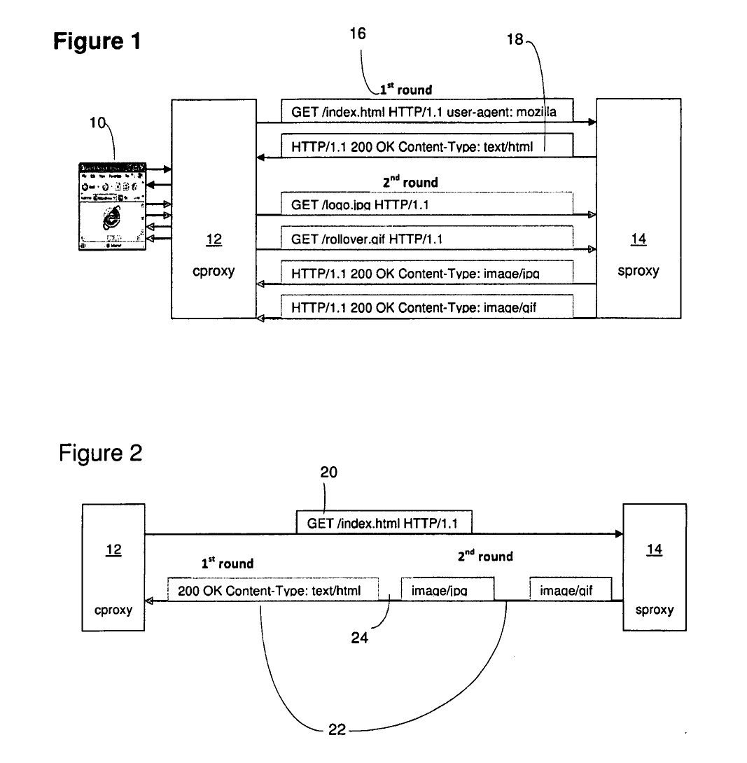

Referring to FIG. 1, browsers 10 create web pages by rendering objects fetched over the Internet from web servers. In doing so, browsers communicate with the web servers using the HTTP protocol. To render a web page, browsers start out by sending out a HTTP GET request 16 to acquire the HTML page. The web server returns a HTTP response 18 containing the HTML page requested. This initial HTTP request-response pair comprises the 1^{st} round of HTTP messages exchanged between browser, cproxy 12, sproxy 14 and an upstream server (not shown). Next, the browser 10 parses that HTML page and identifies all embedded objects needed to render that page. For each embedded object, the browser issues a new HTTP request to the web server through cproxy 12 and sproxy 14, resulting in a 2^{nd} round of HTTP requests followed by their responses. Between the 1^{st} and 2^{nd} round of HTTP messages there is a time delay consisting of the turn-around time of the browser, the round-trip latency of the HTTP messages and the processing delay incurred by cproxy 12, sproxy 14, and an upstream server. Frequently, there is a 3^{rd}, sometimes even a 4^{th} round of HTTP messages depending on the composition of the web page. An example for higher-rounds triggering HTTP messages is a frameset HTML page. In a frameset HTML page each frame segment is another HTML page, which typically embeds further objects. Other examples include pop-up windows and iframe-objects. FIG. 1 visualizes HTTP's request-response style.

FIG. 2 shows that the cproxy 12 sends out requests for embedded objects in a concurrent manner in that a single request or get action 20 begets both a concurrent first round and a second round responsive action 22, or even further round of actions if any after the second round. It does so in order to lessen the round-trip latencies incurred by the HTTP request-response pair as shown in FIG. 1.

The significant time delay due to the processing overhead of cproxy 12, sproxy 14 and browser 10 causes the phenomenon of stop-and-wait. Avoiding these waiting times is key to minimize response time by means of pipelining.

### Space-Time Optimization

The present invention, a CPA (content procurement architecture) was motivated by the observation that the content distribution system today is dominated by duplication of contents.

While this is obvious, the cost of such setup is very costly as contents consume storage space, and the refreshing of duplicated contents consumes tremendous amounts of bandwidth. In the era of dynamic contents today, it is increasingly clear that this old strategy yields a wasteful and unscalable architecture.

The next observation is that web browsers cache more and more contents. Such caching is useful, as human actions are known to be highly repetitive.

The CPA architecture optimizes content distribution in two dimensions: space and time.

In the space dimension, CPA introduces the concept of user object. To each provider content object, a user object corresponding to the provider content object is defined to be either a handle (hash value or hash function output) of the provider content object, or an object describing user interests. Therefore, a possible user object can be a short representation of the actual provider object thereby saving space dimension. Typically, the amount of information contained in a user index object is 1/10 to 1/1000 of the provider content object. For example, a provider content object may be an image; a user index object could be the name of the image, or a caption of the image.

The CPA distribution is accomplished by three logical servers: user proxy, provider proxy, and user browser. Each of them is a logical server that can reside anywhere in the network. Compared to the split-proxy architecture, the user proxy is similar to the client proxy (cproxy 12) and the provider proxy is similar to server proxy (sproxy 14). The browser proxy 34 in the current architecture can represent either the user or the provider. The CPA browser proxy 34 is differentiated by caching user objects and is exclusively used for user purposes.

In the extreme form of the CPA, the browser proxy specifies not the requested objects from the provider, but instead, specifies a set of criteria to get the provider objects; described in the user objects.

In a preferred embodiment, a new type of browser is to be implemented that meet both the requirements of content providers and content users. The content providers are constrained by their offering of objects, and the users are constrained by the interests specified by the user objects (interests).

The implication of the above architecture is that content seen by the user is no longer controlled by the provider, with only minimal user inputs. With this new architecture, the content seen by the user is the results of user-provider jointly agreed or jointly optimized product. This is the concept of content procurement. The current, known content networking can be at best called content delivery with minimal personalization. With CPA, a user can completely personalize his/her view of the web, built from provider content objects.

In terms of physical space, a preferred embodiment pushes the user objects and browser proxies as close as possible to the provider web sites. This will minimize the RTT (round trip time) between the request maker (browser proxy) and the provider proxy, could be either a provider web site or provider proxy.

A key to the efficiency of CPA is that instead of caching objects, index objects are cached. This saves tremendous amount of storage space and data refresh transmission bandwidths.

An application of CPA distribution for wireless content is to be noted here. In a real-world wireless environment, the bandwidth fluctuates dynamically, and noise level can have significant impacts on air quality. Therefore, to combat the fluctuation and high noise, even the data delivery time over the wireless segment can be very significant. For example, currently the data delivery time over a WiBro link offered by KT (Korea Telecom) is at least 50 ms, and can be as high as 200 ms. Such long data delivery time implies that for any transmission over the wireless segment should be minimized. The CPA distribution will greatly reduce the transmission over the wireless segment by moving the user proxy to the wired network.

Another application for CPA is web filtering in the web. Currently, the filtering of unwanted web content is largely done by the user browser after the content has been downloaded. Such an approach slows the web download time and wastes the bandwidths used to send the unwanted content. With CPA, the filtering will be done by the browser proxy 34, far away from the user browser. This will greatly increase the speed of download and conserve the user bandwidth.

In the time dimension, CPA utilizes the concept of parallelization and pipelining to minimize web response time.

To minimize response time, it is critical to identify the components of web response time. At the present, web content is delivered through the HTTP protocol. In a CPA distribution system, any request-response cycle is shortened by moving the request point as close as possible to the response point. For example, in today's HTTP request-response cycle, a web browser will only send out the second round of requests after receiving the HTML file from a server or a sproxy 14. In a preferred embodiment of CPA, the sproxy 14 pre-fetches objects and pipes them back to the cproxy 12, as depicted in FIG. 2 such that text and images 22 are ready to supply by sproxy 14 to cproxy 12 when an index or some indication of interest 20 is provided by cproxy 12.

Notice the small gaps 24 between the pipelined HTTP responses. These small gaps result from processing delay incurred by the sproxy 14, upstream server or sometimes the original content server. It is still possible to minimize these gaps by a plurality of the following methods:
1. Prioritize HTTP response based on content-type and response object size. For instance, a HTTP response containing a large image or an ad can be delayed in favor of a more important HTML response or smaller picture.
2. Aggregate HTTP responses in the sproxy 14 to improve the effectiveness of compression.
3. If the size of an embedded image is less than a threshhold (say 300 bytes) and when sproxy 14 finds that download stream channel is idle, the sproxy 14 refrains from compressing the image. Instead, the cproxy 12 sends the uncompressed image to the cproxy 12.

The following describes an exemplified, preferred embodiments.

### The Split-Proxy Embodiment: Browser Proxy 34 and EOL 32

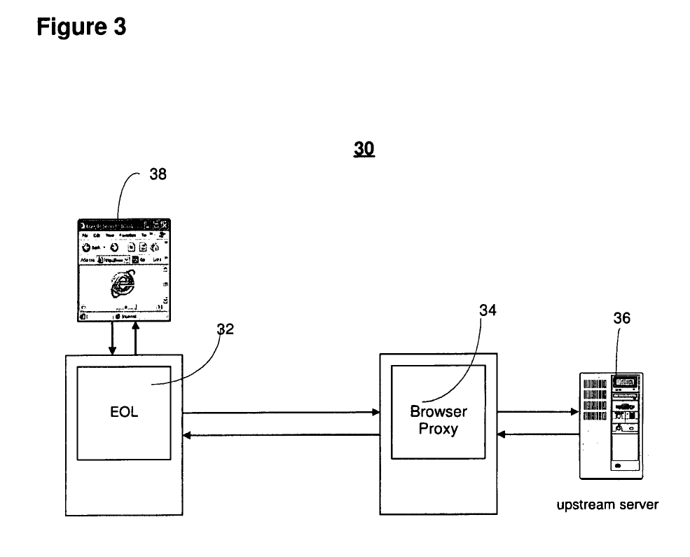

Refering to FIG. 3, to facilitate pipelining of HTTP responses, a preferred embodiment 30 of the CPA distribution system introduces 2 major software components: the Browser Proxy 34 and the Embedded Object List (EOL) 32.

The Browser Proxy 34 is a software component located within the sproxy 14. It parses the 1st-round HTTP responses to get a list of embedded objects. For each embedded object it decides whether or not to fabricate a HTTP request and issue it to the upstream server 36. These decisions are based on the information contained in the 1st-round response and the browser's caching situation.

The Embedded Object List 32 is an in-memory data structure holding embedded objects in the form of HTTP responses. The vast majority of HTTP requests can be satisfied out of the content of the EOL 32. The HTTP responses remain in the EOL 32 for only a very short time, more precisely until the browser 38 finishes rendering a particular web page.

Putting all components together, FIG. 3 shows the new components of the split-proxy embodiment 30 of CPA.

The basic request-response structure of CPA is that, when a URL for a container page is requested by a user, the client sends, along with that request, a list (“the manifest”) of the relevant objects currently cached by the user (via browser) along with the request.

On the server side the container page is obtained (either from server side cache or the web site). Then the container page is parsed enough to generate the list of contained objects.

Finally, all objects in that list which are not in the manifest are sent to the client immediately following the container page (having been obtained either from the server side cache or the web site.)

### The Split-Proxy Embodiment: Cache Manifest

To enable the Browser Proxy to pre-process the web page correctly, it is necessary to know which objects reside in the browser's cache. The CPA pipelining model solves this issue by fabricating a set of signatures for cached objects—the cache manifest—and transferring it to the Browser Proxy. There are 2 approaches in transferring the cache manifest; first, transferring the cache manifest at start-up time and second, transferring a subset of the cache manifest with each request.

According to a preferred embodiment, the cache manifest is transferred together with each 1st-round HTTP request using piggybacking. The cache manifest consists of only page-related objects and no cache coherency messages are transferred. This approach, neither requires maintaining a copy of the browser's cache in the Browser Proxy, nor requires complex coherency messages to be exchanged between cproxy 12 and Browser Proxy.

Designing the piggybacking mechanism raises several architectural questions:
1. How can individual cache objects be identified?
2. How can the size of the piggybacked cache manifest be kept small?
3. How does piggybacking the cache manifest impact the performance?

### Cache Object Identification

According to a preferred embodiment, uniquely identification of cached objects is accomplished by means of expanded object identifiers. An expanded object identifier is a tuple consisting of an extended URL and HTTP headers. An extended URL is an ordinary URL appended with name-value pairs. Extended URLs have the following format:
scheme://domainname/path?name=value
   An example of an extended URL is given here:
http://www.foo.com/scripts/query.asp?author=Csikszentmihalyi&title=Flow
   This extended URL consists of the scheme (http), the domain name (www.foo.com), a path (/scripts/query.asp), and a list of name-value pairs separated by the ampersand character (&) (author=Csikszentmihalyi&title=Flow). A question mark (?) separates the path from the name-value pairs.

Whenever the referenced web page expects input from a cookie, the HTTP header of an expanded URL can contain the Set-Cookie entity header. The format of the Set-Cookie entity header is given here:

Set-Cookie: <cookie-data>

The extended URL approach has the following pros and cons:

### Pros:

Hierarchical name space: A binary search can to be conducted across an ordered hierarchical tree of expanded object identifiers. This search operation has an order of O(log n).
Contain information about the referencing object. For each embedded object, the Browser proxy 34 can use the URL (and the expiration date) to decide on the fly whether or not the browser will fetch this embedded object from its cache.

### Cons:

Large size: The size of an expanded object identifier has the order of 100 s of bytes.

The large size requirements of expanded object identifiers can be dramatically reduced by using compression. According to Slipstream's estimate, the average HTTP header size is just 40 bytes. Due to this statement, we estimate the resulting size of the expanded object identifier to range from 10 to 30 bytes after compression. (The expanded object identifier is a subset of an HTTP header.)

According to a preferred embodiment, an HTTP header compression algorithm splits the URL into 2 portions: First, static portion URL, second the name-value pairs. The static portion remains unchanged for most HTTP messages related to the same web site. With a web page dictionary, the compression algorithm replaces the static part of a URL into a small byte-size key. The name-value pairs are shrunk by regular text compression.

### Minimizing the Size

It is infeasible to piggyback the entire browser cache manifest. A browser may hold thousands of objects resulting in an aggregate size of 10 to 30 Mbytes. Instead, by creating a piggybacked cache manifest of related web objects, it is possible to reduce the number of cache manifest objects to only a couple of dozens. With this approach, the size of the cache manifest to vary between 100 and 1500 bytes, possibly less than 1460 bytes, which is the common MSS size of the TCP/IP protocol used in the Internet today.

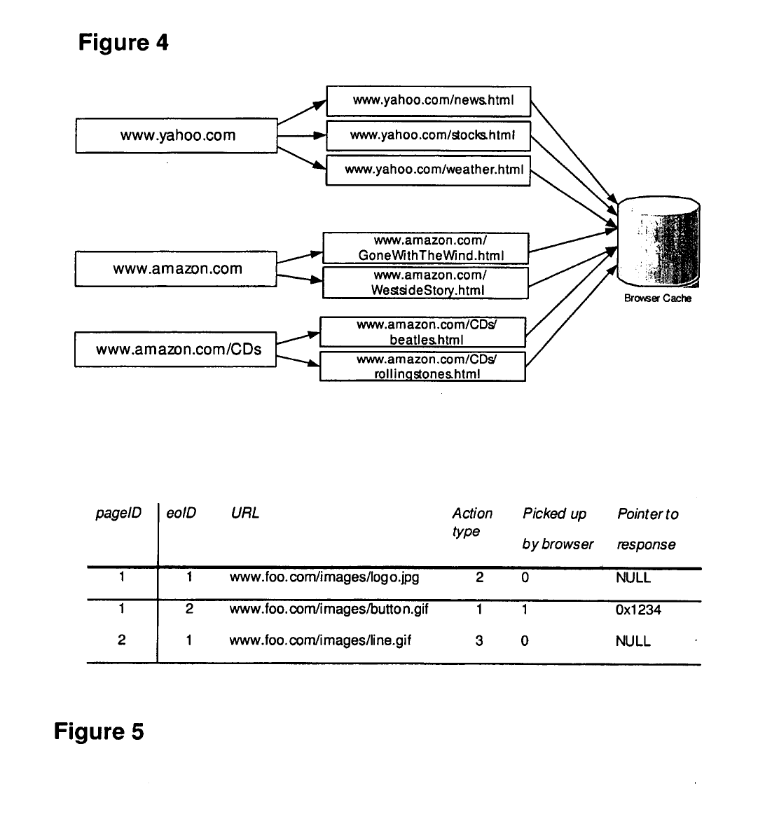

To create a manifest of related objects, there is no need to loop through the entire browser cache. The cproxy 12 has already made provisions for it. It keeps a hash of pointers to related cached objects in memory. Reconstructing the cproxy 12 code, the hash of related objects can be represented with the schematics 400 shown in FIG. 4. As can be seen in FIG. 4, a browser proxy 402 is introduced between sproxy 14 and upstream server 36 or integrated within the sproxy to the client-side browser. Browser proxy 402 receives at least on http response from 36 and sends a stream of http response to cproxy 12. Further, browser proxy 402 receives a cache manifest from 14, which was received from cproxy 12.

### Embedded Object List

Unlike ordinary HTTP message exchange, the CPA pipelining model does not preserve the request-response order of HTTP messages. Therefore, the pipelining model calls for a mechanism to match HTTP requests with their responses.

The pipelining model faces another challenge: A user may create multiple browser instances and use them simultaneously to surf the web. This web surfing style results in a concurrent exchange over the same tunnel connection that need to be differentiated. The same type of problem exists when a user interrupts an unfinished page download and request a new web page.

The pipelining model solves latter problem with the pageID-identifier and the former with the embeddedObjectID-identifier.

### PageID

The pipelining model uses pageIDs to group HTTP messages related to the same web page. HTTP messages originating from distinct browser instances are assigned different pageIDs.

### EmbeddedObjectID

The embeddedObjectID—or eoID—enables matching of HTTP requests and responses within the scope of the same pageID.

Each HTTP response holds the pageID and eoID. Arriving responses must be temporarily stored until they are matched with their request. The data structure facilitating the request-response matching is the Embedded Object List (EOL) 32. The EOL 32 is a list of entries representing objects requested by the browser. Each entry consists of a pageID, eoID, expanded URL, action type, pickedUpByBrowser bit, and a pointer to the HTTP response. PageID and eoID are used for matching requests with responses. The request-handling algorithm uses the expanded URL and action type fields. The pickedUpByBrowser bit facilitates statistical analysis and the pointer to response references the HTTP response, if present. FIG. 5 shows sample entries of the EOL 32.

### Sproxy: Request and Response Handling

2 types of HTTP request arrive at the sproxy 14: Pass-thru HTTP requests and 1st-round HTTP requests.

Pass-thru requests pass through the sproxy 14 without any additional action (besides the usual decoding and decompression). HTTP responses that are following pass-thru requests also require no further processing.

1st-round requests follow a different processing pattern. They are marked as such and passed-on to the upstream server. When the upstream server sends back a 1st-round response, the sproxy 14 will handle them in its Browser proxy 34, as discussed in the next section.

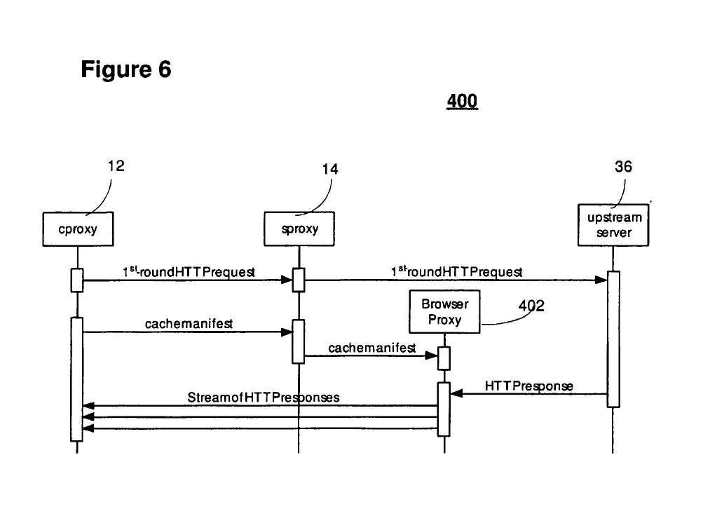

A 1st-round request is followed by its cache manifest. The sproxy 14 receives the cache manifest and makes it available to the Browser proxy 34. FIG. 6 depicts the sproxy 14's request and response handling.

### Browser Proxy

The Browser proxy 34 is a software component integrated within the sproxy 14. It functions as a proxy to the client-side browser 10. The Browser proxy 34 pre-processes the 1st-round HTTP responses and pipes all HTTP responses back to the browser 10, ideally before the actual requests arrive there.

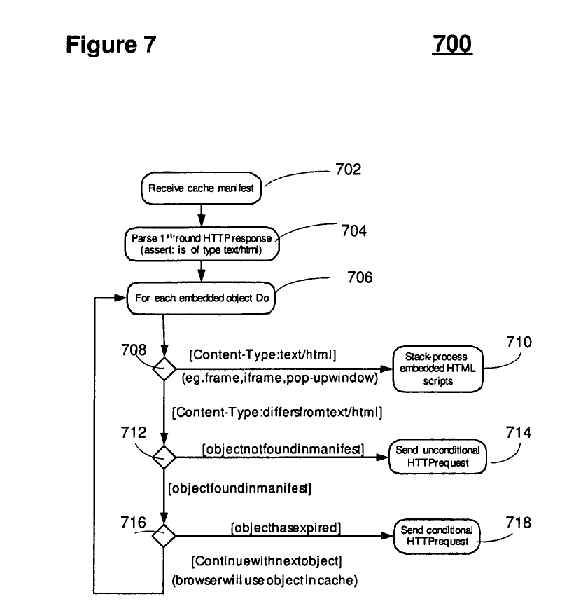

FIG. 7 shows a UML action diagram 700 of the Browser Proxy's control flow.

Browser proxy 34 receives a cache manifest (Step 702). After the Browser proxy 34 has received the cache manifest, the 1st-round HTTP response it and parses the HTTP response for embedded objects(Step 704). Embedded objects of MIME type text/html (such as frames, iframes or pop-up windows) are temporarily saved in a stack of 2nd-round text/html embedded objects called the 2nd-round EOL 32. After the Browser proxy 34 has finished parsing the 1st-round HTML it re-visits the 2nd-round EOL 32. This sequence of actions ensures minimal latencies on the 1st-round responses as the browser 10 might be waiting for those.

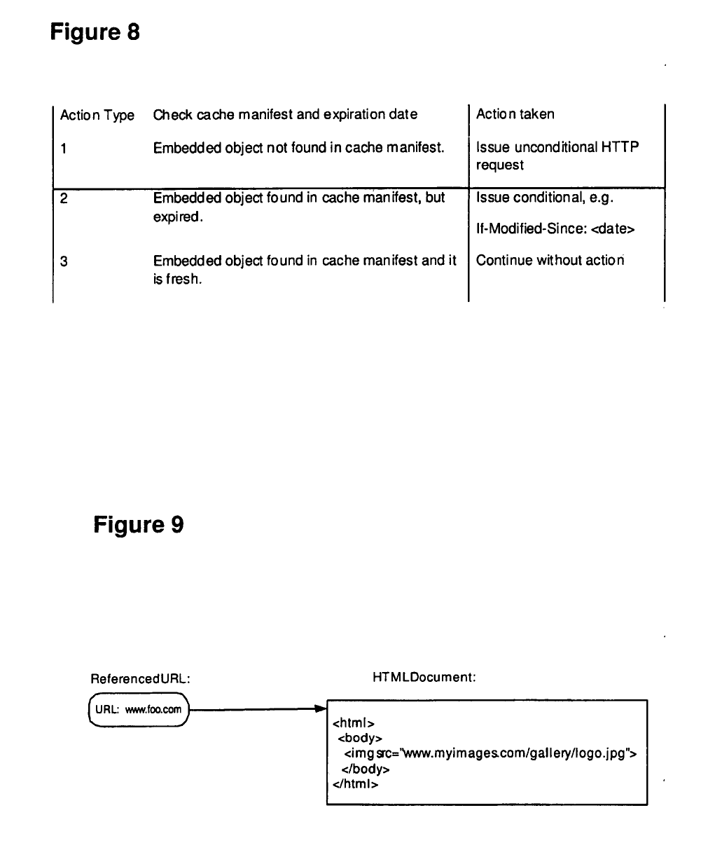

If the Browser proxy 34 cannot find an embedded object in the cache manifest it fabricates a new unconditional HTTP request and issues this request to the upstream server. The upstream server handles this request as if the browser 10 issued it. If on the other hand, the Browser proxy 34 finds a matching but expired object in the cache manifest it issues a conditional HTTP request (IMS request) to the upstream server. And finally, if the Browser Process finds a matching and fresh object in the cache manifest it does not need to take any action since the browser 10 can satisfy the object request from its local cache. FIG. 8 defines these 3 cases of embedded objects together with their action taken.

In other words, if a first condition 708 is met, stack process embedded HTML scripts (Step 710). If a second condition 712 is met, send unconditional HTTP request (Step 714). If a third condition 716 is met, send unconditional HTTP request (Step 718). The process loops back to Step 706. FIG. 8 shows a table of three classes associated with the three conditions for handling embedded objects.

Request Handling. The cproxy 12 must differentiate between 1st and 2nd-round requests originated at the browser 10. 1st-round requests are forwarded to the sproxy 14 while 2nd-round request shell be satisfied directly from the cproxy 12. The cproxy 12 may accomplish this by initially, comparing the domain name of the URL contained in the 1st-round HTTP request header with the domain name in a 2nd-round response header. If they both match the request ought to be 2nd-round, otherwise be the 1st-round. However this approach falls short when a 2nd-round HTTP request contains the fully qualified URL of a third-party domain.

FIG. 9 illustrates this situation. The HTML document for the URL www.foo.com contains a link to an image in the www.myimages.com domain.

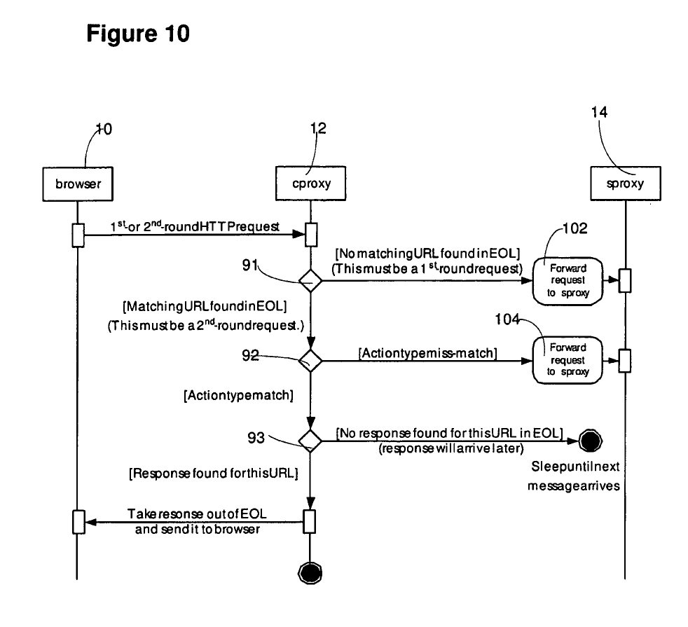

Because of the shortcoming of the differentiation based on URL concept, a differentiation based on EOL 32 approach is introduced. In this approach, the cproxy 12 re-creates an identical copy of the EOL 32 based on the data provided by the 1st-round response and the cache manifest. If a request's URL is matched with a URL entry in the EOL 32, then it is indeed a 2nd-round request. Otherwise it is still in 1st-round. FIG. 10 shows the interaction diagram 100 for differentiation based on EOL 32 approach together with the rest of the request handling logic. Browser 10 communicates with cproxy 12 via a first or a second round of HTTP request from browser 10 to cproxy 12. Browser 10 further communicates with cproxy 12 via a response taken by cproxy 12 out of EOL 32 and sent to browser 10. cproxy 12 communicates with sproxy 14 via a set of three conditions. First condition 91, if no matching URL is found in EOL 32, the request or the information must be a first round request. In turn the information 102 is forwarded to sproxy 14. Second condition, if the action type is a missing match, the information 104 is also forwarded to sproxy 14. Third condition 93, if no response is found for the URL in EOL 32, information in not forwarded at all and the process stops until the next message arrives.

After a browser-issued request has been matched with an URL inside the EOL 32, the cproxy 12 verifies the match of the action type. A miss match indicates that the browser 10 and Browser proxy 34 do not agree on the existence and/or expiration of cached objects. This is the case when during the time gap between sending the cache manifest and the sending of a request, a browser-cached object may be deleted, may expire, or become corrupted. If so, the browser 10 overrides the decision made by the Browser proxy 34 and triggers the transmission of a 2nd-round request to the sproxy 14, wherein it will be processed and the correct response returned to the cproxy 12. However, for the vast majority of requests the action type does match.

In the next step, the cproxy 12 queries the EOL 32 for the existence of the response. If no response is found yet, the cproxy 12 goes to sleep and wakes up later when a next message arrives. If, on the other hand, the cproxy 12 finds a matching response it will be taken out of the EOL 32 and send to the browser 10. This completes the processing of a request-response pair.

### Response Handling

When HTTP responses arrive at the cproxy 12, they are marked as 1st-round and 2nd-round responses. In the case of a 1st-round response, the cproxy 12 immediately forwards this response to the browser 10 so that further web page processing can take place. Next, the cproxy 12 parses the 1st-round response for embedded objects and inserts them into the EOL 32. At this point, the cproxy 12 goes to sleep waiting for the next message to arrive. FIGS. 3-8 show how the cproxy 12 handles 1st-round responses.

If the arriving response belongs to the 2nd-round, the cproxy 12 searches the EOL 32 for a matching entry. This search is based on the pageID and eoID that are new components of the tunnel header. The cproxy 12 stores the pointer to that 2nd-round response into the matching EOL 32 field and goes to sleep. FIG. 3-9 shows the interaction diagram for the handling of 2nd-round HTTP responses.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A communication system comprising:
a browser operatively or signally coupled to a cproxy; and
a sproxy operatively or signally coupled to the cproxy.

2. The system of claim 1 further comprising a server disposed upstream to the browser, to the cproxy, or to the sproxy.

3. The system of claim 1, wherein the coupling between the cproxy and the sproxy comprises communicating requests from the cproxy to the sproxy.

4. The system of claim 1, wherein the coupling between the cproxy and the sproxy comprises communicating a cache manifest from the cproxy to the sproxy.

5. The system of claim 1 further comprising a browser proxy integrated within the sproxy proximate to the client-side browser.

6. The system of claim 5, wherein when the browser proxy cannot find an embedded object in the cache manifest, a new unconditional HTTP request is fabricated and a request issued to an upstream server.

7. The system of claim 5, wherein when the browser proxy finds a matching but expired object in the cache manifest a conditional HTTP request (IMS request) is issued to the upstream server.

8. The system of claim 5, wherein when Browser proxy finds a matching and fresh object in the cache manifest it does not need to take any action since the browser 10 can satisfy the object request from its local cache.

9. The system of claim 5 wherein filtering will be done by the browser proxy, as far away from the user browser as practicable.

10. The system of claim 5 wherein the browser proxy is differentiated by caching user objects and is exclusively used for user or browser purposes.

11. The system of claim 5 wherein the browser proxy specifies not the requested objects from the provider, but instead, specifies a set of criteria to get the provider objects; described in the user objects.

12. The system of claim 1, wherein content providers are constrained by their offering of objects, and users or browsers are constrained by the interests specified by user objects (interests); and contents seen by a user is the results of user-provider jointly agreement or a jointly optimized product.

13. The system of claim 1, wherein user objects and browser proxies are respectively pushed as close as possible to provider web sites.

14. The system of claim 1, wherein instead of caching objects, indices of the objects are cached.

15. The system of claim 1, wherein if the communication line or channel comprises both wired and wireless portions, the user proxy is moved to the wired network.

16. A system comprising:
means for accelerating web response time;
means for providing a level platform to meet the interests from both at least one provider and at least one user of content; and
means for pushing user interests close to provider sites thereby minimizes the request-response time between a user proxy and a provider proxy.

17. The system of claim 16, wherein the means for providing the level platform comprise at least one user object associated with a user or a browser.

18. The system of claim 16, wherein, if a user or a browser has already cached a particular provider object, a corresponding user object indicates that the user or browser is not interested in the particular provider object.

19. The system of claim 16, wherein, if a user or a browser has not cached a particular provider object, a user or browser can indicate interests in objects specified, either by a set of criteria, or explicit description of objects.

20. The system of claim 16, wherein the means for accelerating web response time comprises a request-response sequence, which is accelerated by pipelining and minimizing all unnecessary stop-and-wait actions and the provider proxy.
